(19) United States
(12) Patent Application Publication
(10) Pub. No.: US 2009/0228380 A1
(43) Pub. Date: Sep. 10, 2009

(54) CENTRALIZED CLASSIFICATION AND RETENTION OF TAX RECORDS

(75) Inventor: Eugene S. Evanitsky, Pittsford, NY (US)

Correspondence Address: Gibb Intellectual Property Law Firm, LLC, 2568-A Riva Road Suite 304, Annapolis, MD, 21401, US

(73) Assignee: XEROX CORPORATION, Norwalk, CT (US)

(21) Appl. No.: 12/045,336

(22) Filed: Mar. 10, 2008

(51) Int. Cl. G06Q 40/00

(52) U.S. Cl. 705/31

(57) ABSTRACT

A method embodiment herein has a central storage device periodically receiving images of documents. These documents have written or printed thereon financial information and can relate to a single tax entity. These images are supplied from at least one remote device over a network. The images are processed (at the central storage device) to classify the images according to tax classifications and to extract the financial information from the images. With this information, the financial information can also be classified into tax classifications. This method also accumulates, over a tax period (e.g., tax year), the images and the financial information in the tax classifications as the images are periodically received by the central storage device to create an accumulation of financial information and a corresponding accumulation of images. From this accumulation of financial information for the tax year, the method prepares tax reports and outputs the tax reports.

### BACKGROUND AND SUMMARY

Embodiments herein generally relate to tax record storage systems and more particularly to a centralized storage system, method, and service, that receives image inputs from remote devices over a wide area network.

Embodiments herein are accessible via a browser. A service provided herein organizes specific types of documents such as those related to income tax. Any paper document can be a source of input. Thus, embodiments herein provide a convenient way to organize and extract the appropriate information from piles of paper documents, including items such as cash register receipts for business, medical expenses, donations, tax payments, etc.

Each year, millions of taxpayers must file various tax forms. Most of the information that they, or a tax preparer, must sort through is in paper form. This is a tedious and error prone exercise to categorize each document, receipt, etc. and extract the data. Further, in some areas, the documents need to be kept on file for many (e.g., 7) years.

A method embodiment herein has a central storage device that periodically receives images of documents. These documents have written or printed thereon financial information and can relate to a single tax entity (e.g., user) and can comprise receipts, check book records, and other similar documents that need to be retained for the preparation of tax returns. These images are supplied from at least one remote device over a network. Thus, the images could be photographs of documents from cell phones or personal digital assistants (PDAs) received over a cellular telephone network, or could be scanned images provided through a public or personal copier, scanner, fax machine, etc.

The images are processed (at the central storage device) to classify the images according to tax classifications and to extract the financial information from the images. Thus, for example, image clarification and optical character recognition can be performed on the images at the central storage device.

With this information, the financial information can also be classified into tax classifications. The single tax entity can also be provided with an opportunity to approve or change the tax classifications into which the images and the financial information are classified.

This method also accumulates, over a tax period (e.g., tax year), the images and the financial information in the tax classifications as the images are periodically received by the central storage device to create an accumulation of financial information and a corresponding accumulation of images. From this accumulation of financial information for the tax year, the method prepares tax reports and outputs the tax reports. In addition, the method can store one or more tax years of the accumulation of financial information and the corresponding accumulation of images.

This disclosure also presents system embodiments. One such embodiment includes a central device that periodically receives the images of the documents that contain the financial information and are supplied from at least one remote device over a network to which the central device is connected. As stated above, the images could be photographs of documents from cell phones or personal digital assistants (PDAs) received over a cellular telephone network, could be scanned images scanned on a public or personal copier, scanner, fax machine, etc. Again, such documents relate to a tax entity.

In addition, a processor is contained within or operatively connected to the central device and processes the images at the central device to extract the financial information from the images. The processor can process the images, or a separate image processor (that again is either contained within or operatively connected to central device) can process the images to perform image clarification and optical character recognition.

Further, the processor can classify the financial information and images into tax classifications, or a separate classifier (that again is either contained within or operatively connected to central device) can perform such classification. Similarly, the processor can accumulate information or a separate accumulator (that again is either contained within or operatively connected to central device) can accumulate, over a tax year, the images and the financial information into the tax classifications as the images are periodically received by the central device. This creates an accumulation of the financial information and a corresponding accumulation of the images. Also, the processor can generate tax reports, or a separate report generator (that again is either contained within or operatively connected to central device) can prepare tax reports from the corresponding accumulation of financial information for the tax year.

An interface that is contained within (or operatively connected to) the central device outputs the tax reports. The interface provides the user an opportunity to approve or change the tax classifications into which the financial information is classified. Further, a computer storage device can store years (e.g., the last 7 years) of the accumulation of financial information and the corresponding accumulation of images to free the user from having to maintain such information.

Therefore, embodiments herein accept, or create digital images of the unstructured documents; and sort, categorize and extract data from using “trained” technology. The embodiments herein store the images, metadata and categorized data for the end user and produce files with the tagged data that can be imported into popular tax programs or the data can be summarized in tables that can be printed or viewed.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating an embodiment herein;

FIG. 2 is a flow diagram illustrating an embodiment herein;

FIG. 3 is a flow diagram illustrating an embodiment herein;

FIG. 4 is a flow diagram illustrating an embodiment herein; and

FIG. 5 is a schematic representation of a system according to embodiment herein.

### DETAILED DESCRIPTION

As mentioned above, maintaining and classifying tax documents is a tedious and error prone exercise. Therefore, this disclosure presents a personal method, system, computer product, and service that can be used by any tax entity, from individuals or joint filers, to large businesses. In brief, a tax entity collects documents throughout the year that must be processed to extract data for their tax forms. These documents come from employers, banks, and investment firms, but they also may include receipts, donation descriptions, business expenses, etc.

With embodiments herein, the tax entity can go to an on-line portal and create a tax document folder. The tax entity enters some pertinent tax related information to establish their account with the on-line portal, after which the user can periodically submit image files of each document. The users can do this by using a personal scanner; they can go to a retail copier, or some other provider to scan the documents to media; or they can use the camera in their cell phones to take an image of the document and transfer it to their folder.

The embodiments herein automatically identify each document, determine to which tax category the document belongs, and extract the tax data elements contained in the document. The user can optionally verify the accuracy of the results and modify the classifications and financial amounts as needed. Documents can be added anytime throughout the year. When it is time to fill out tax forms, the user selects the option to generate a data file that can be imported into popular tax software programs or a human readable summary. The image files can be stored for many years in the event of an audit.

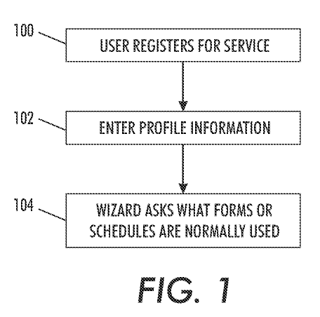

As shown in flowchart form in FIG. 1, user registers for the service 100, and enter profile information 102 that may include data about their tax returns, such as home business, etc. A wizard may ask what forms or schedules are normally used 104. This will help in the categorization process to identify business expenses, etc.

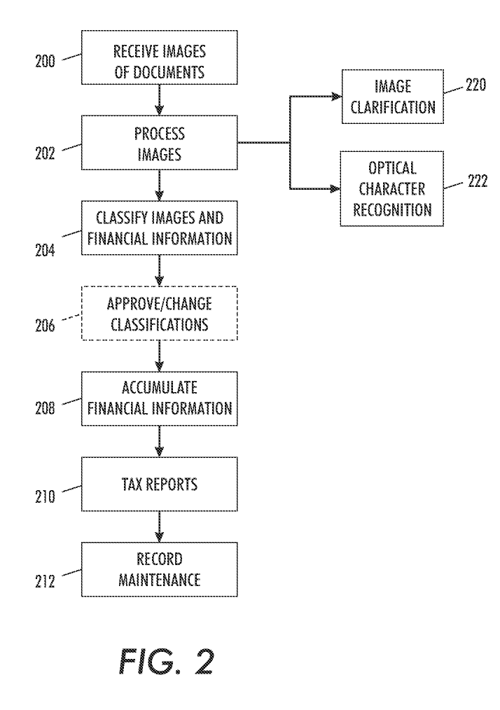

As shown in flowchart form in FIG. 2, the method periodically receives images of documents in item 200. These documents have written or printed thereon financial information and can relate to a single tax entity (e.g., user) and can comprise receipts, check book records, and other similar documents that need to be retained for the preparation of tax returns. These images are supplied from at least one remote device over a network. Thus, the images could be photographs of documents from cell phones or personal digital assistants (PDAs) received over a cellular telephone network, could be scanned images scanned on a public or personal copier, scanner, fax machine, etc.

The images are processed in item 202 (at the central storage device) to classify the images according to tax classifications and to extract the financial information from the images. Thus, for example, image clarification 220 and optical character recognition 222 can be performed on the images at the central storage device.

With this information, the financial information can also be classified into tax classifications in item 204. The single tax entity can also be provided with an opportunity to approve or change the tax classifications into which the images and the financial information are classified in item 206.

In contrast to localized record-keeping systems, the embodiments herein can train the classification engines using feedback 206 from a large number of tax entities. This allows the embodiments herein to develop a much larger information base and much more sophisticated classification engines when compared to localized record-keeping systems. Therefore, the embodiments herein present a dramatic increase in classification precision which increases user satisfaction.

This method also accumulates (in item 208), over a tax period (e.g., tax year) the images and the financial information in the tax classifications as the images are periodically received by the central storage device to create an accumulation of financial information and a corresponding accumulation of images. From this accumulation of financial information for the tax year, the method prepares tax reports and outputs the tax reports in item 210. In addition, the method can perform record maintenance by storing one or more tax periods (e.g., tax years) of the accumulation of financial information and the corresponding accumulation of images in item 212.

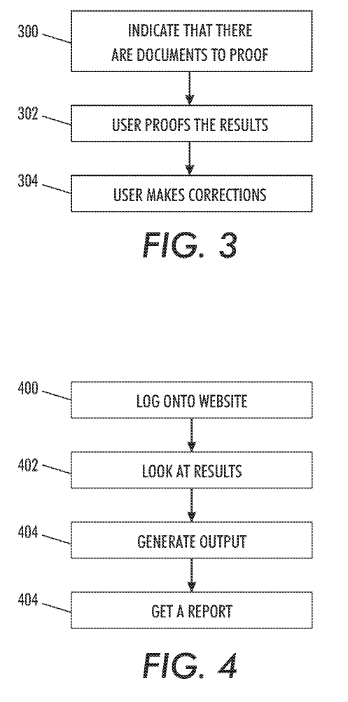

As shown in flowchart form in FIG. 3, a desktop link to the service can indicate that there are documents to proof 300. The user proofs the results 302, and makes corrections 304 where necessary for the system to learn. The proofing 302 and correcting 304 may take place at a different time sequence than the document submission (FIG. 2). If the user is going through their mail and scanning or taking pictures of documents, he or she may not do the proofing until they go on line.

As shown in flowchart form in FIG. 4, at the end of the year, the user can log onto the website 400 to look at the results 402 and to generate output 404 for their CPA, tax s/w, IRS auditors etc., and/or to get a report 406.

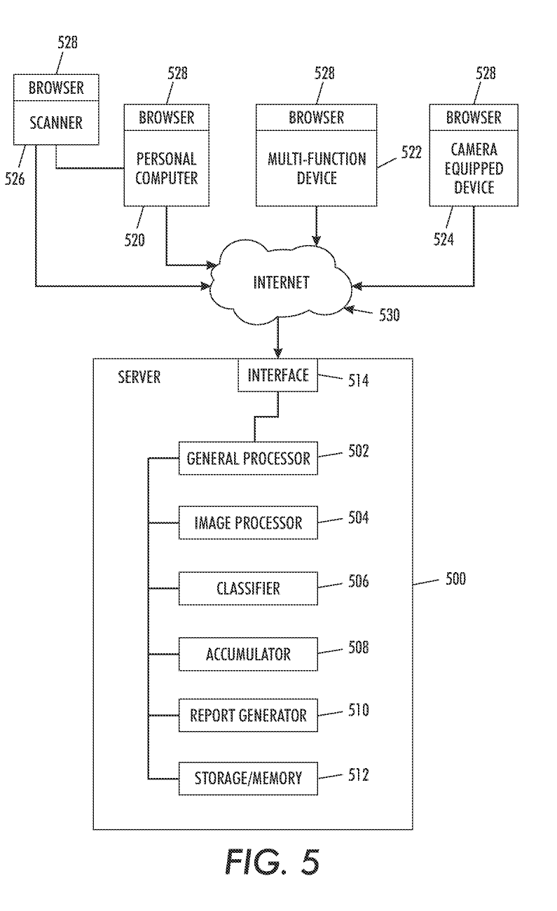

This disclosure also presents system embodiments. One example of such embodiments is shown in FIG. 5 and includes a central device 500 that periodically receives the images of the documents that contain financial information and are supplied from one or more remote devices 520-524 over a network 530 to which the central device 500 is connected. The network 530 can be a local area network (e.g., an intranet) or a wide area network (e.g., the internet). The central device 500 can comprise any form of computerized server systems, such as website servers, file servers, and associated storage servers.

The remote devices can include a personal computer 520 which can be connected to a scanner 526. Alternatively, the remote device can be a multifunction device 522 (fax, copier, scanner, etc.). The remote device can be any device capable of obtaining an image such as a digital camera, cell phone, etc., and such items are shown in FIG. 5 as item 524. Thus, the images could be photographs of documents from cell phones or personal digital assistants (PDAs) received over a cellular telephone network, or could be scanned images scanned on a public or personal copier, scanner, fax machine, etc., sent over a network. A user accesses the server (or service) via their browser 528 (via their PC or their cell phone, PDA etc.) running on any of the remote devices 520-526 to verify and correct data and to order reports and exports.

Therefore, with embodiments herein, a user who just performed a transaction which has tax implications could take a picture of the associated document with their cell phone 524, and send the picture of the document over the cellular telephone network 530 to the central device 500. This would allow the user to dispose of the document, because the information contained within the document will be maintained by the central device 500.

In addition, a general processor 502 is contained within or operatively connected to the central device 500. The processor 502 processes the images at the central device 500 to extract the financial information from the images. The processor 502 can process the images, or a separate image processor 504 (that again is either contained within or operatively connected to central device 500) can process the images to perform image clarification and optical character recognition. For example, the image processor 504 can be used to search the documents for specific data to extract data such as social security numbers, dates, monetary values, addresses, etc.

Systems for clarifying images and extracting data from images and scanned documents, as well as trainable classification systems are well known to those ordinarily skilled in the art and the details of such systems are not discussed herein. Such systems can utilize commercially available handwriting recognition and optical character recognition (OCR) systems and trainable classification systems. For example, see U.S. Pat. Nos. 6,178,270; 7,331,523; 7,321,688; 7,167,849; 6,892,189, the complete disclosures of which are incorporated herein by reference.

Further, the processor 502 can classify the financial information and images into tax classifications, or a separate classifier 506 (that again is either contained within or operatively connected to central device 500) can perform such classification. For example, the classifier can identify that a tip was added to a receipt, indicating that the receipt should be classified as an entertainment expense. Alternatively, the retailer of the receipt can be identified, and the receipt can be classified according to the types of products that the retailer provides.

As mentioned above, the classifier 506 can initially comprise a somewhat simplified classifier that is trained as users supply feedback containing corrections/modifications that are consistent with the manner in which users desire items to be classified. Because the embodiments herein are utilized by large numbers of tax entities, this training process allows the classifier 506 to become very sophisticated in a manner that would not be available to local recordkeeping systems (that might receive feedback from a very limited number of users).

The processor 502 can accumulate information or a separate accumulator 508 (that again is either contained within or operatively connected to central device 500) can accumulate, over a tax year, the images and the financial information into the tax classifications as the images are periodically received by the central device 500. This creates an accumulation of the financial information and a corresponding accumulation of the images. Also, the processor 502 can generate tax reports, or a separate report generator 510 (that again is either contained within or operatively connected to central device 500) can prepare tax reports from the corresponding accumulation of financial information for the tax year.

An interface 514 that is contained within (or operatively connected to) the central device 500 outputs the tax reports. The interface 514 provides the user an opportunity to approve or change the tax classifications into which the financial information is classified. Further, a computer storage device 512 (magnetic tape, hard disk, electronic memory, etc.) that is contained within (or operatively connected to) the central device 500 can store at least one tax period (e.g., the last 7 years) of the accumulation of financial information and the corresponding accumulation of images to free the user from having to maintain such information.

Various computerized devices are mentioned above. Computers that include input/output devices, memories, processors, etc. are readily available devices produced by manufactures such as International Business Machines Corporation, Armonk N.Y., USA and Apple Computer Co., Cupertino Calif., USA. Such computers commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Stamford, Conn., USA and Visioneer, Inc. Pleasanton, Calif., USA and the details of such devices are not discussed herein for purposes of brevity and reader focus.

The word “printer” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. Printers are readily available devices produced by manufactures such as Xerox Corporation, Stamford, Conn., USA. Such printers commonly include input/output, power supplies, processors, media movement devices, marking devices etc., the details of which are omitted herefrom to allow the reader to focus on the salient aspects of the embodiments described herein.

Thus, with embodiments herein, the user scans the document on their home scanner or multifunction device and then drags the image onto a tax document service folder. Next, the image is transmitted to the centralized, web based host server for processing, or the user can use their cell phone to take a picture of the document and then send it directly to the host server with the user's ID so that the system knows where it came from. The documents are automatically recognized, categorized and metadata is extracted. When the user goes on line, they can verify that this process was done correctly. If not, they can provide corrections which the system will “learn” for next time.

Embodiments herein can be specific to tax programs or can generally apply to many different arenas which require extensive recordkeeping over long periods of time. Tax documents are fairly well defined and there are a finite set of classifications, which simplifies any training sets that are to be created for the document analysis. Further, as users submit more documents, the system learns more and becomes more accurate.

With embodiments herein, users do not have to purchase or learn expensive software for OCR, categorization, data extraction etc. In addition, the method/system provides a very simple intuitive interface. Capturing the images is also easy using a scanner connected to a PC with internet service, or using a digital camera or cell phone for capturing the image and transmitting a photograph directly to the central device. Further, the image processor and classifier can be trained to recognize documents from large sample sets, which individual users do not have access to. In addition, users of the embodiments herein do not have to store the image files, which can be large.

All foregoing embodiments are specifically applicable to electrostatographic and/or xerographic machines and/or processes as well as to software programs stored on the electronic memory (computer usable data carrier) and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A method comprising:
periodically receiving, by a central device, images of documents comprising financial information supplied from at least one remote device over a network, wherein said documents relate to a tax entity;
processing said images at said central device to extract said financial information from said images;
classifying said financial information into tax classifications;
accumulating, over a tax period, said images and said financial information in said tax classifications as said images are periodically received by said central device to create an accumulation of financial information and a corresponding accumulation of images;
preparing tax reports from said accumulation of financial information for said tax period; and
outputting said tax reports.

2. The method according to claim 1, all the limitations of which are incorporated herein by reference, further comprising providing said tax entity an opportunity to approve or change said tax classifications into which said financial information is classified.

3. The method according to claim 1, all the limitations of which are incorporated herein by reference, wherein said processing comprises performing image clarification and performing optical character recognition at said central device.

4. The method according to claim 1, all the limitations of which are incorporated herein by reference, further comprising storing at least one tax period of said accumulation of financial information and said corresponding accumulation of images.

5. The method according to claim 1, all the limitations of which are incorporated herein by reference, wherein said periodically receiving of said images comprises receiving photographs of said documents from said remote device over a cellular telephone network.

6. A method comprising:
periodically receiving, by a central storage device, images of documents comprising financial information supplied from at least one remote device over a network, wherein said documents relate to a single tax entity;
processing said images at said central storage device to classify said images according to tax classifications and to extract said financial information from said images;
classifying said financial information into corresponding tax classifications;
accumulating, over a tax year, said images and said financial information in said tax classifications as said images are periodically received by said central storage device to create an accumulation of financial information and a corresponding accumulation of images;
preparing tax reports from said accumulation of financial information for said tax year; and
outputting said tax reports.

7. The method according to claim 6, all the limitations of which are incorporated herein by reference, further comprising providing said single tax entity an opportunity to approve or change said tax classifications into which said images and said financial information are classified.

8. The method according to claim 6, all the limitations of which are incorporated herein by reference, wherein said processing comprises performing image clarification and performing optical character recognition at said central storage device.

9. The method according to claim 6, all the limitations of which are incorporated herein by reference, further comprising storing at least one tax year of said accumulation of financial information and said corresponding accumulation of images.

10. The method according to claim 6, all the limitations of which are incorporated herein by reference, wherein said periodically receiving of said images comprises receiving photographs of said documents from said remote device over a cellular telephone network.

11. A system comprising:
a central device that periodically receives images of documents comprising financial information supplied from at least one remote device over a network operatively connected to said central device, wherein said documents relate to a tax entity;
a processor operatively connected to central device that processes said images at said central device to extract said financial information from said images;
a classifier operatively connected to central device that classifies said financial information into tax classifications;
an accumulator operatively connected to central device that accumulates, over a tax period, said images and said financial information in said tax classifications as said images are periodically received by said central device to create an accumulation of financial information and a corresponding accumulation of images;
a report generator operatively connected to central device that prepares tax reports from said corresponding accumulation of financial information for said tax period; and
an interface operatively connected to central device outputting said tax reports.

12. The system according to claim 11, all the limitations of which are incorporated herein by reference, wherein said interface provides said tax entity an opportunity to approve or change said tax classifications into which said financial information is classified.

13. The system according to claim 11, all the limitations of which are incorporated herein by reference, further comprising an image processor operatively connected to central device that performs image clarification and optical character recognition.

14. The system according to claim 11, all the limitations of which are incorporated herein by reference, further comprising a computer storage device that stores at least one tax period of said accumulation of financial information and said corresponding accumulation of images.

15. The system according to claim 11, all the limitations of which are incorporated herein by reference, wherein said central device periodically receives photographs of said documents from said remote device over a cellular telephone network.

16. A computer program product comprising:
a computer-usable data carrier storing instructions that, when executed by a computer, cause the computer to perform a method comprising:
periodically receiving, by a central device, images of documents comprising financial information supplied from at least one remote device over a network, wherein said documents relate to a tax entity;
processing said images at said central device to extract said financial information from said images;
classifying said financial information into tax classifications;
accumulating, over a tax period, said images and said financial information in said tax classifications as said images are periodically received by said central device to create an accumulation of financial information and a corresponding accumulation of images;
preparing tax reports from said corresponding accumulation of financial information for said tax period;
outputting said tax reports.

17. The computer program product according to claim 16, all the limitations of which are incorporated herein by reference, further comprising providing said tax entity an opportunity to approve or change said tax classifications into which said financial information is classified.

18. The computer program product according to claim 16, all the limitations of which are incorporated herein by reference, wherein said processing comprises performing image clarification and performing optical character recognition at said central device.

19. The computer program product according to claim 16, all the limitations of which are incorporated herein by reference, further comprising storing at least one tax period of said accumulation of financial information and said corresponding accumulation of images.

20. A service comprising:
periodically receiving, by a central device, images of documents comprising financial information supplied from at least one remote device over a network, wherein said documents relate to a tax entity;
processing said images at said central device to extract said financial information from said images;
classifying said financial information into tax classifications;
accumulating, over a tax period, said images and said financial information in said tax classifications as said images are periodically received by said central device to create an accumulation of financial information and a corresponding accumulation of images;
preparing tax reports from said accumulation of financial information for said tax period; and
outputting said tax reports.
